(19) United States
(12) Patent Application Publication
(10) Pub. No.: US 2003/0021047 A1
(43) Pub. Date: Jan. 30, 2003

(54) Method and apparatus for safe lane changing

(76) Inventor: Dean Dixon, Calgary (CA)

Correspondence Address: Milton Wolson, Esq., Malina & Wolson, Suite 501, 60 East 42nd Street, New York, NY, 10165, US

(21) Appl. No.: 10/202,819

(22) Filed: Jul. 25, 2002

(30) Foreign Application Priority Data
Jul. 27, 2001 (CA) 2,354,258

(51) Int. Cl. G02B 7/182

(52) U.S. Cl. 359/871

(57) ABSTRACT

A reference mechanism for a vehicle mirror for indicating to a driver when it is safe to change lanes comprising a first indicia positionable on the mirror to provide a point of reference for use by the driver to orient the mirror relative to the vehicle and a second indicia positionable on the mirror to provide, based on the position of a reflected vehicle relative to the second indicia, a visual indication of whether it is safe to change lanes, where the second indicia indicates it is safe to change lanes when the reflected vehicle is seen completely on the side of the second indicia that is closest to the driver.

### FIELD OF THE INVENTION

The present invention relates to an aid for drivers to determine when it is safe to change lanes and specifically to an aid that is affixed to a vehicle's side mirrors and that provides a reference to indicate to a driver when it is safe to change lanes.

### BACKGROUND TO THE INVENTION

Most automobiles on the road or being built today provide side mirrors to enable a driver to determine what is behind him or her and whether it is safe to change lanes. In order to maximize the field of view and reduce blind spots, most passenger side mirrors are convex in shape. This creates the advantage that a wider field of view is visible, but creates the problem that the image the driver sees is distorted. Specifically, the driver sees an image that appears to be further away than it really is.

Vehicle manufacturers attempt to warn the driver of this disadvantage by printing a warning directly on the mirror, indicating that the objects in the mirror are closer than they appear. However, this warning doesn't aid a driver to determine when another vehicle is sufficiently far behind to enable a safe lane change. Thus in situations such as when overtaking another vehicle, a driver cannot generally rely on the passenger side mirror to indicate when it is safe to return to the original lane the driver was in. A shoulder check is therefore necessary.

Several solutions have been created to attempt to overcome the above problem. These include U.S. Pat. No. 5,644,442 to Lemere, which teaches the use of two vertical lines placed on a side mirror. These lines are placed on the centre of the mirror and are used to help a driver determine when it is safe to change lanes. Lemere teaches that a vehicle will be framed within the two lines when it is safe to merge, and will be wider than the width between the two lines when it is unsafe to merge.

There are, however, a number of disadvantages to the Lemere invention. The first is the situation when a vehicle does not appear exactly centred between the two lines. This situation makes it difficult to determine whether it is safe to merge. Since the position of the reflection of vehicles in the mirror varies based on their actual position in relationship to the driver's vehicle, in a significant percentage of cases the vehicle being passed will not be centred in the mirror.

Further, the Lemere invention depends on the relative size of the reflection in order to determine whether it is safe to merge. However, vehicles come in many different sizes and the Lemere invention has the same preset width for the lines. Thus when judging whether it is safe to merge in front of a transport truck, a compact car or even a motorcycle, the driver has the same two lines to use as a reference. The width can therefore in some cases be too wide or too narrow, and does not accurately indicate when merging is safe.

A further solution is taught by U.S. Pat. No. 5,917,666 to Kimble. This patent teaches the use of a series of rectangular frames affixed to the centre of a mirror. A number of frames are included to accommodate different sized vehicles. The principle of operation for Kimble is again based on the size of the object, and Kimble, while trying to accommodate various sized vehicles, has the same disadvantages as those in Lemere. Those are that the vehicle being passed must be centred on the mirror for the invention to work effectively, and that the size of the vehicle will again be a factor in the decision on whether to merge. In Kimble, the series of frames may also confuse a driver who must determine which set of frames to use.

### SUMMARY OF THE INVENTION

Unlike the prior art, the present invention uses the position of the reflection on the vehicle's mirror rather than the relative size of this reflection. This overcomes many of the disadvantages of the prior art by ensuring that the driver does not have to guess whether it is safe to merge based on the size of the vehicle. The present invention further counts on the position of the reflected vehicle changing on the mirror as the two vehicles get closer to one another, and uses this change in the reflection's position to the advantage of the driver.

In the present invention there are provided two vertical lines. The first is used to ensure the mirror is correctly aligned for the driver. This is done by aligning the first line with the side of the vehicle.

The second line is used as an indicator to determine whether it is safe to pass. This line is also vertical and is horizontally offset from the first line. If a vehicle appears on the left of the line it is safe to merge. If any part of the vehicle appears on the right of the line it is unsafe to merge.

Accordingly, the present invention therefore provides a reference mechanism for a vehicle mirror for indicating to a driver when it is safe to change lanes comprising: a first indicia positionable on the mirror to provide a point of reference for use by the driver to orient the mirror relative to the vehicle; and a second indicia positionable on the mirror to provide, based on the position of a reflected vehicle relative to said second indicia, a visual indication of whether it is safe to change lanes; wherein said second indicia indicates it is safe to change lanes when the reflected vehicle is seen completely on the side of said second indicia that is closest to the driver.

The present invention further provides a reference device for a vehicle for indicating to a driver when it is safe to change lanes comprising: a substrate having a reflective surface configured to provide the driver of a vehicle an image of what is behind the vehicle; a first indicia positioned on said substrate, said first indicia providing a reference for the driver to allow the driver to orient said substrate relative to the vehicle; and a second indicia positioned on said substrate, said second indicia providing a visual indication to the driver of whether it is safe to change lanes; wherein said second indicia indicates to the driver it is safe to change lanes when the reflected vehicle is seen on said substrate completely on the side of said second indicia that is closest to the driver.

The present invention yet further provides a method for indicating to a driver of a vehicle when it is safe to change lanes comprising the steps of: positioning a first indicia on a mirror of the vehicle adjacent to an edge of the mirror closest to the vehicle to provide a reference to orient the mirror for the driver relative to the side of the vehicle; positioning a second indicia on the mirror so that the second indica provides a visual reference for the driver indicating when it is safe to change lanes; wherein said second indicia indicates to the driver it is safe to change lanes when the reflected vehicle is seen on the mirror completely on the side of said second indicia that is closest to the driver.

The present invention yet further provides a method of judging when it is safe to change lanes in a vehicle comprising the steps of: orienting a mirror relative to the vehicle by using a first indicia as a reference by overlapping said first indicia with a reflection of a side of the vehicle as seen by the driver; and using a second indicia as a reference to indicate when it is safe to change lanes based on the viewed position of a reflected vehicle on the vehicle mirror relative to the position of said second indicia; wherein said second indicia indicates to the driver it is safe to change lanes when the reflected vehicle is seen on the mirror completely on the side of said second indicia that is closest to the driver.

### BRIEF DESCRIPTION OF THE DRAWINGS

FIG. 1 is a frontal view of a preferred embodiment of the present invention.

FIG. 2 is a frontal view of a preferred embodiment of the present invention further including the reflection of a vehicle.

FIG. 3 is a frontal view of a preferred embodiment of the present invention further including the reflection of a vehicle that is closer than the vehicle in FIG. 2.

### DETAILED DESCRIPTION

The following disclosure discusses, and the drawings illustrate, the use of indicator system on a mirror on the right hand side of a vehicle. This is merely done for convenience and is not intended to limit the present invention in any way. It is envisioned that the present system could also be used on a left side mirror.

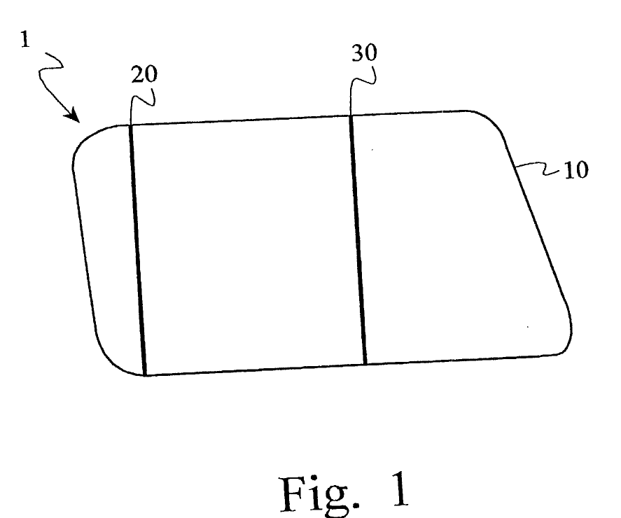

Reference is now made to the drawings. FIG. 1 shows a preferred embodiment of indicator system 1

Indicator system 1 is affixed to mirror 10 and includes a first alignment line 20. In a preferred embodiment, alignment line 20 consists of a vertical line and is affixed to the mirror close to the left edge. Alternative embodiments are however contemplated by the inventor, and include dotted or curved lines, or any type of indicator which can be used to properly align mirror 10 relative to the passenger side of the vehicle.

More specifically, alignment line 20 is used to help a driver ensure the mirror is correctly positioned by enabling a driver to easily position alignment line 20 for registration with the side of the driver's vehicle. Alignment line 20 is important since the position of a reflected vehicle is used to determine whether it is safe to pass, and therefore the mirror should be consistently positioned to ensure the driver can rely on the other parts of indicator system 1.

Indicator system 1 further includes a second vertical reference line 30. Reference line 30 is used to indicate whether the reflected vehicle is sufficiently far behind the driver to allow the driver to change lanes. Alternative embodiments for reference line 30 may include indicators such as dotted lines or shapes, among others, that can be used to help a driver determine when it is safe to change lanes.

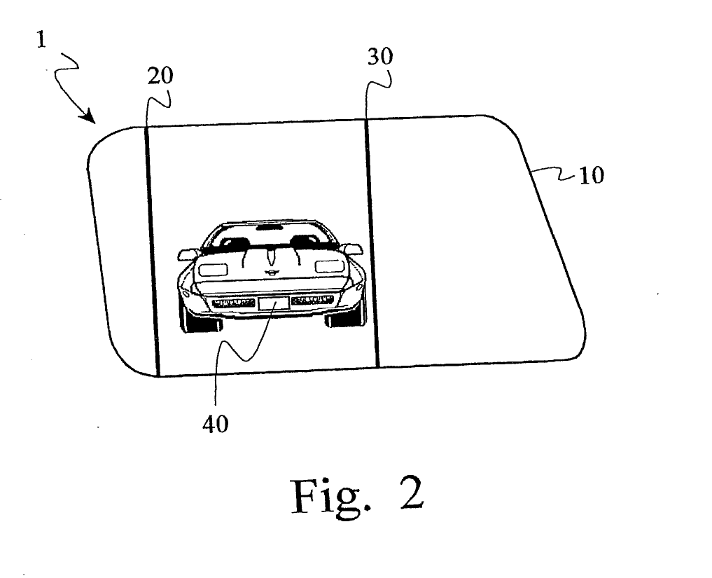

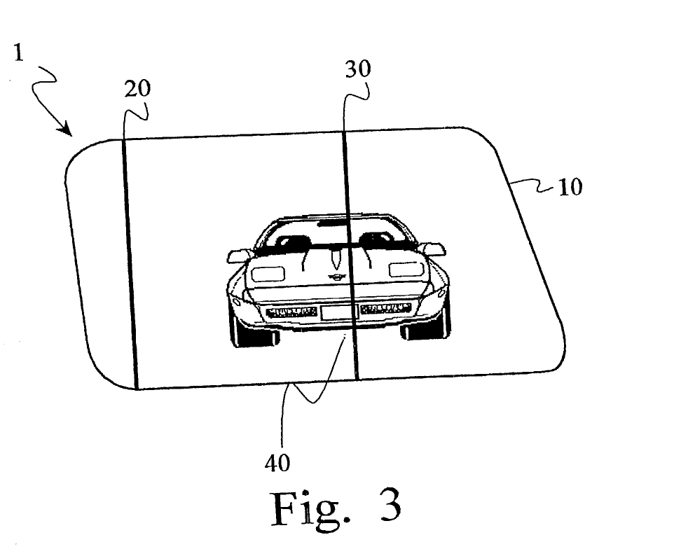

When a vehicle is seen completely to the left of reference line 30 this indicates that it is sufficiently far behind the driver to change lanes and that it is safe to merge. If the reflected vehicle is seen even partially on the right of reference line 30, it indicates to the driver that the vehicle is too close to safely change lanes. This is best illustrated in FIGS. 2 and 3.

FIG. 2 shows the reflection of a vehicle 40 that is being overtaken. Vehicle 40 is seen on the left side of reference line 30, and the driver therefore knows that it is safe to merge. Similarly, in FIG. 3 vehicle 40 is being overtaken. However, in this figure vehicle 40 is seen partially to the right of reference line 30, and the driver knows that it is therefore unsafe to merge.

In a preferred embodiment, lines 20 and 30 are permanently affixed to the mirror 10 using adhesive. However, other embodiments are envisioned, including original equipment or aftermarket mirrors with the lines printed or etched onto the mirror surface.

The horizontal distance between lines 20 and 30 is determined by the curvature of the mirror. Different brands of automobiles have variously curved mirrors, and no preset spacing is therefore available. The spacing is further determined by the size of the vehicle. In a preferred embodiment the spacing will show that it is safe to pass when the front bumper of a vehicle is a predetermined distance behind the rear bumper of the driver's vehicle. At this point the reflection of the vehicle behind the driver should be completely to the left of reference line 30. If a vehicle is less than this distance away from the driver's vehicle, the reflection should be at least partially to the right of reference line 30.

In a preferred embodiment, the distance between the rear bumper of the driver's vehicle and the front of the other vehicle will be 35 feet (10.7 m). However, this could be varied based on the manufacturer's or owner's preference at the time the reference lines are added onto the mirror.

Once the distance is set, the vehicle driver will be informed that reference line 30 indicates a vehicle that is X number of feet or metres behind the vehicle, where X is the distance from the mirror to the front bumper of the other vehicle. This distance, rather than the distance between the rear bumper of the driver's vehicle and the other vehicle's front bumper, will be conveyed to the driver to ensure that if a drive is towing something, or has a pick-up bed open, or does anything else to extend the length of the vehicle, the driver will still have an accurate distance reference to work with.

The above-described embodiments of the present invention are meant to be illustrative of preferred embodiments and are not intended to limit the scope of the present invention. Various modifications, which would be readily apparent to one skilled in the art, are intended to be within the scope of the present invention. The only limitations to the scope of the present invention are set forth in the following claims appended hereto.

The embodiments of the invention in which an exclusive property or privilege is claimed are defined as follows:

1. A reference mechanism for a vehicle mirror for indicating to a driver when it is safe to change lanes comprising:
a first indicia positionable on the mirror to provide a point of reference for use by the driver to orient the mirror relative to the vehicle; and
a second indicia positionable on the mirror to provide, based on the position of a reflected vehicle relative to said second indicia, a visual indication of whether it is safe to change lanes;
wherein said second indicia indicates it is safe to change lanes when the reflected vehicle is seen completely on the side of said second indicia that is closest to the driver.

2. The reference mechanism of claim 1 wherein said first indicia and said second indicia are markings.

3. The reference mechanism of claim 2 wherein said first indicia and said second indicia are horizontally spaced apart vertical lines.

4. The reference mechanism of claim 3 wherein said first indicia indicates to the driver that the mirror is correctly oriented when said first indicia overlaps with a reflection of a side of the vehicle as seen by the driver.

5. A reference device for a vehicle for indicating to a driver when it is safe to change lanes comprising:
a substrate having a reflective surface configured to provide the driver of a vehicle an image of what is behind the vehicle;
a first indicia positioned on said substrate, said first indicia providing a reference for the driver to allow the driver to orient said substrate relative to the vehicle; and
a second indicia positioned on said substrate, said second indicia providing a visual indication to the driver of whether it is safe to change lanes;
wherein said second indicia indicates to the driver it is safe to change lanes when the reflected vehicle is seen on said substrate completely on the side of said second indicia that is closest to the driver.

6. The reference device of claim 5 wherein said substrate is convex.

7. The reference mechanism of claim 6 wherein said first indicia and said second indicia are lines.

8. The reference mechanism of claim 7 wherein said first indicia and said second indicia are vertical lines that are horizontally spaced apart.

9. The reference mechanism of claim 5 wherein said first indicia indicates to the driver that said substrate is correctly oriented when said first indicia overlaps with a reflection of a side of the vehicle as seen by the driver.

10. A method for indicating to a driver of a vehicle when it is safe to change lanes comprising the steps of:
positioning a first indicia on a mirror of the vehicle adjacent to an edge of the mirror closest to the vehicle to provide a reference to orient the mirror for the driver relative to the side of the vehicle;
positioning a second indicia on the mirror so that the second indica provides a visual reference for the driver indicating when it is safe to change lanes;
wherein said second indicia indicates to the driver it is safe to change lanes when the reflected vehicle is seen on the mirror completely on the side of said second indicia that is closest to the driver.

11. The method of claim 10 wherein said positioning said second indicia comprises locating said second indicia on the mirror such that a reflected vehicle whose front bumper is less than a predetermined distance from the rear bumper of the driver's vehicle is seen overlapping said second indicia.

12. The method of claim 11 wherein the predetermined distance is about 35 feet.

13. The method of any of claim 12 wherein said first indicia and said second indicia are comprised of markings.

14. The method of claim 13 wherein said first indicia and said second indicia are horizontally spaced apart vertical lines.

15. A method of judging when it is safe to change lanes in a vehicle comprising the steps of:
orienting a mirror relative to the vehicle by using a first indicia as a reference by overlapping said first indicia with a reflection of a side of the vehicle as seen by the driver; and
using a second indicia as a reference to indicate when it is safe to change lanes based on the viewed position of a reflected vehicle on the vehicle mirror relative to the position of said second indicia;
wherein said second indicia indicates to the driver it is safe to change lanes when the reflected vehicle is seen on the mirror completely on the side of said second indicia that is closest to the driver.

16. The method of claim 15 wherein said first indicia and said second indicia are markings.

17. The method of claim 16 wherein said first indicia and said second indicia are horizontally spaced apart vertical lines.
